(19) United States
(12) Patent Application Publication
(10) Pub. No.: US 2011/0114415 A1
(43) Pub. Date: May 19, 2011

(54) Belay device with a sliding slack bar

(76) Inventor: YOUNG CHU, (US)

(21) Appl. No.: 12/592,097

(22) Filed: Nov. 18, 2009

(51) Int. Cl. A62B 1/14

(52) U.S. Cl. 182/5

(57) ABSTRACT

A manual belaying device for belaying a climber on a single or double rope, comprised of an aluminum body having two slots, a U-shaped bracket, and a diagonal slack bar. Each slot is for a rope to pass through, and the U-shaped bracket is for a carabiner to attach to the rope and the device. The collapsible sliding slack bar is set diagonally so the carabiner can slide side to side, to provide friction for the belayer if the climber is falling, but to allow for the climber to get slack easily on the rope if pulling in the opposite direction.

### FIELD OF THE INVENTION

This invention relates to a device used, in conjunction with a rope, to stop a falling object and/or to lower an object in a controlled manner. In particular it pertains to a manual belay device used in the sport of rock climbing.

### BACKGROUND OF THE INVENTION

In rock climbing, a belay device is used to protect a climber from injury in case of a fall. The climber wears a harness to which one end of a rope is attached. The rope passes through a belay device that is attached to the harness of another person (“belayer”). In case the climber falls, the belayer must grasp the rope and stop the fall of the climber by means of the belay device, necessitating frictional forces on the device.

At various points during the ascent, the climber clips the rope into metal loops (“carabiners”) that are attached to the rock formation. To accomplish this action, the climber needs as much as eight feet of rope to be fed through the belay device almost instantly. If the climber cannot attain sufficient rope in one quick movement, the climber is “short-roped,” and the climber may lose his balance and fall from his position.

Since the primary objective of a belay device is to stop the fall of a climber, manual belay devices rely on frictional forces that develop as the rope travels through its path to stop the movement of the rope. However, these same forces are detrimental to the ascent of a climber when the rope needs to travel quickly through the belay device the opposite direction, but encounter the same frictional forces.

Due to the dangers involved in climbing, a need exists for belay devices which are reliable and durable. The device must also have frictional forces on the rope to arrest the fall of a climber, but still allow for easy passage of the rope in the opposite direction for the ascent of the climber. The present invention fulfills these needs as described and claimed below.

### SUMMARY OF INVENTION

The present invention is a belay device for climbing with at least one rope. It has an aluminum body composed of a central plate where a U-shaped bracket is fitted bounding two symmetrical slots on each side of the central plate. A sliding slack bar is attached to the body in a slanted manner that gives the slack bar spring action.

The collapsible sliding slack bar is set up so that the carabiner is forced to slide off-center, along the bar, towards the climber side of the rope. This reduces the friction to the belayer side of the rope, as there is a bigger opening. The reduced friction allows for quick rope movement in that single direction, eliminating the chance of being short-roped. At the same time, the friction needed to arrest the fall of a climber still exists when the rope is pulled in the opposite direction. The sliding slack bar moves up and gets flat when the belaying hand side rope is pulled, so the carabiner can slide towards belaying hand side to offer maximum friction.

### BRIEF DESCRIPTION OF THE DRAWINGS

FIG. 1 presents two view of the Belay Device With A Sliding Slack Bar. The left view shows the slack bar in down position, while the right view shows the slack bar in up position.

FIG. 2 presents a view of a traditional manual belay device, and illustrates the mode of use of such a device.

FIG. 3 presents a view of the Belay Device With A Sliding Slack Bar and illustrates the mode of use of such a device.

FIG. 4 presents a side-by-side view of the traditional manual belay device (right), and the Belay Device With A Sliding Slack Bar (left) and illustrates the modes of uses of each. It also illustrates the changed friction point and larger opening provided by the sliding slack bar that allows for free movement of the rope in one direction.

FIG. 5 is a perspective view of the Belay Device With A Sliding Slack Bar.

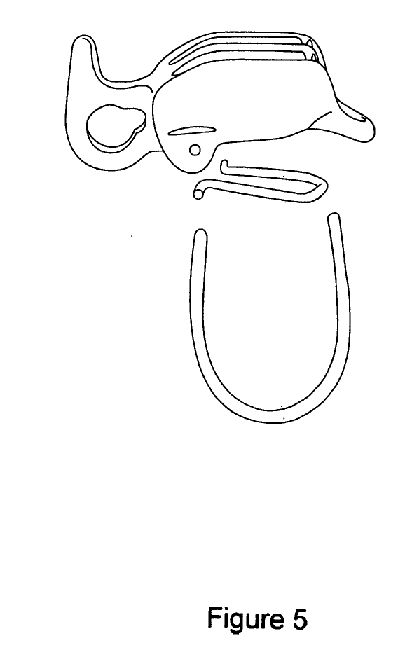

### DETAILED DESCRIPTION OF THE INVENTION

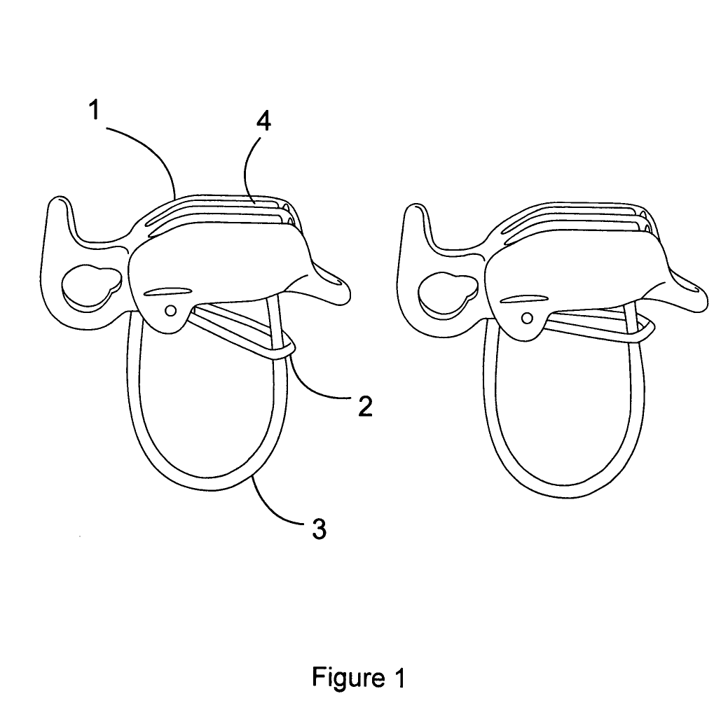

With reference to FIG. 1, the Belay Device With A Sliding Slack Bar includes a main aluminum body 1, with two parallel slots 4, for ropes to feed through. A U-shaped bracket 3 is fitted in to the main body 1 with circular holes so that the U vertically away from the main body 1 and parallel to the two slots 4. A sliding slack bar 2 is connected to the inside of the main body 1 through two circular holes on opposite sides of the main body 1, which allows for the slack bar to be bent towards the main body, but still spring back into its main location. The sliding slack bar 2 must be fitted in a diagonal fashion starting with the attachment points of the sliding slack bar 2 to the main body 1 running away from the main body 1.

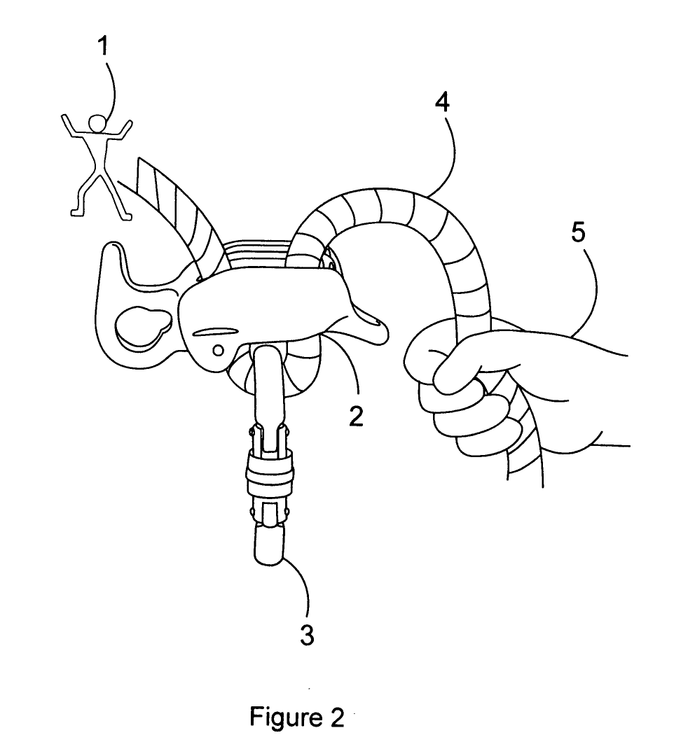

With reference to FIG. 2, the traditional manual belay device provides a lot of friction designed to stop the climber from falling while belayed. The rope 4 feeds through the belay device and is hooked through a carabiner 3 which is attached to a harness on the belayer 1. When the belayer 1 pulls on the rope, it creates friction between the carabiner 3, the rope 4, and the belay device. When the climber 5 needs slack to hook onto a carabiner attachment on the rock, he is unable to get slack quickly because of the friction point 2. The same friction works whichever direction the rope is pulled.

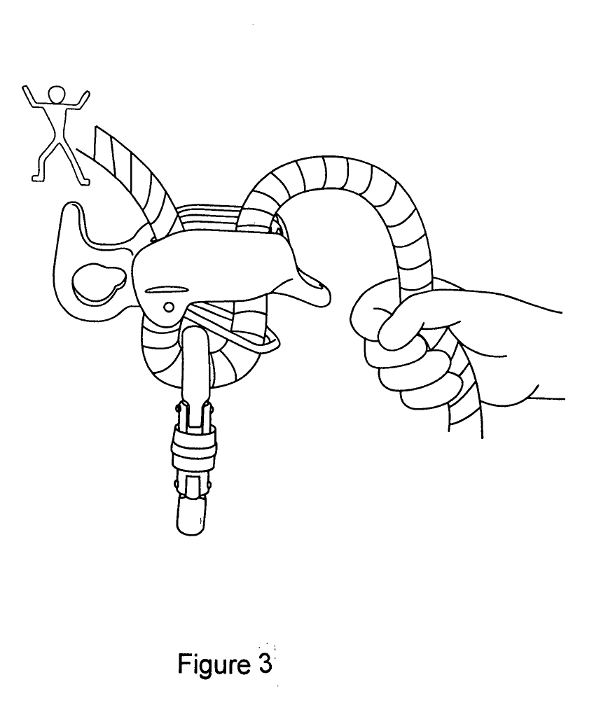

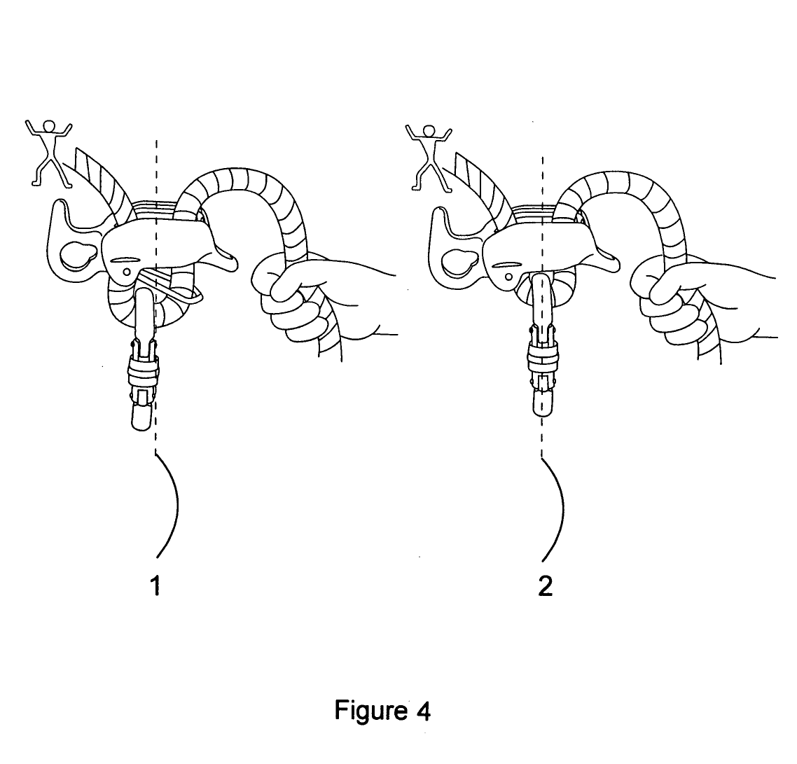

However, with reference to FIGS. 3 and 4, the same problem does not exist. The sliding slack bar keeps the carabiner from being pulled against the body of the belay device as well as keeping the carabiner off-center. It now maintains different resistances when the rope is pulled in opposing directions. When the belayer pulls on the rope, the same friction as the traditional manual belay device is maintained and the climber's fall would be stopped. However, when pulled in the opposite direction, the same friction does not exist. Because of the off-center placement of the carabiner in relation to the body of the belay device due to the sliding slack bar, there is now a larger opening for the rope to move, allowing for free movement in one direction. FIG. 4 illustrates the changed position of the rope, and the lack of a friction point directly to the right of the carabiner when the sliding slack bar is in place. Hence, when the climber needs slack, the rope easily travels through the belay device in that direction, and the climber will not be in danger of being short-roped. Further, when the belaying hand side rope is pulled, the sliding slack bar moves up and gets flat, and so, the carabiner can slide towards belaying hand side to offer maximum friction.

What is claimed is:

1. A manual belaying device comprising an aluminum body having: a pair of slots for one or two ropes to pass through, a U-shaped bracket attached through which a carabiner can attach through the rope, and a diagonal collapsible sliding slack bar attached to the inside of the main body in a manner that prevents the carabiner from hitting the main body of the belay device and that forces the carabiner to an off-center position, towards the climber side of the carabiner. This positioning of the carabiner provides for space for the rope to traverse freely in one direction, but maintains friction points when pulled in the opposite direction. The sliding slack bar moves up and gets flat when the belaying hand side rope is pulled, so the carabiner can slide towards belaying hand side to offer maximum friction.
